(19) United States
(12) Patent Application Publication
(10) Pub. No.: US 2017/0260067 A1
(43) Pub. Date: Sep. 14, 2017

(54) TREATMENT OF SUBTERRANEAN WELLS WITH ELECTROLYZED WATER

(71) Applicants: John M. Hopkins, Orem, UT (US); James K. Stone, Lindon, UT (US); William R. Shupe, Lindon, UT (US)

(72) Inventors: John M. Hopkins, Orem, UT (US); James K. Stone, Lindon, UT (US); William R. Shupe, Lindon, UT (US)

(21) Appl. No.: 15/605,862

(22) Filed: May 25, 2017

Related U.S. Application Data
(63) Continuation of application No. 13/552,418, filed on Jul. 18, 2012, now abandoned.
Application No. 13/552,418 is a continuation-in-part of application No. 13/549,265, filed on Jul. 13, 2012.
(60) Provisional application No. 61/509,018, filed on Jul. 18, 2011.
(60) Provisional application No. 61/507,458, filed on Jul. 13, 2011.

(51) Int. Cl. C02F 1/461; E21B 43/20; E21B 43/267

(52) U.S. Cl. CPC C02F 1/4618; E21B 43/267; E21B 43/20

(57) ABSTRACT

Systems and methods for using one or more electrolyzed aqueous solutions to treat subterranean reservoirs containing hydrocarbons are disclosed herein. In some cases, the methods include using an electrochemical cell to produce electrolyzed acidic water, electrolyzed alkaline water, and/or stabilized acidic water. In such cases, the electrolyzed acidic water, the electrolyzed alkaline water, and/or the stabilized acidic water is introduced to the well. While the electrolyzed water can be used for a variety of purposes, in some cases, it is used to improve hydraulic fracturing, water flooding, and well stimulation techniques. In some cases, the electrolyzed water is mixed with one or more other materials, such as a proppant, a hydraulic fracturing fluid, a polymer, or another additive. Additional implementations are disclosed.

### CROSS-REFERENCE TO RELATED APPLICATIONS

This is a continuation of U.S. patent application Ser. No. 13/552,418 (Attorney Docket No. 20890.6), filed Jul. 18, 2012, entitled “TREATMENT OF SUBTERRANEAN WELLS WITH ELECTROLYZED WATER,” and claims the benefit of U.S. Provisional Application No. 61/509,018 (Attorney Docket No. 20890.4), filed Jul. 18, 2011, entitled “TREATMENT OF HYDROCARBON CONTAINING PETROLEUM RESERVOIRS WITH ELECTROLYZED WATER,” the entire disclosures of which are hereby incorporated by reference.

This is also a continuation-in-part of U.S. patent application Ser. No. 13/549,265 (Attorney Docket No. 20890.5), filed Jul. 13, 2012, entitled “TREATMENT OF HYDROCARBON CONTAINING RESERVOIRS WITH ELECTROLYZED WATER,” and claims the benefit of U.S. Provisional Application No. 61/507,458 (Attorney Docket No. 20890.3), filed Jul. 13, 2011, entitled “TREATMENT OF HYDROCARBON CONTAINING PETROLEUM RESERVOIRS WITH ELECTROLYZED WATER,” the entire disclosures of which are hereby incorporated by reference.

### FIELD OF THE INVENTION

This invention relates to systems and methods for enhanced recovery of hydrocarbons from a hydrocarbon containing reservoir. More specifically, in some implementations, this invention relates to the use of electrolyzed water (such as electrolyzed acidic water, electrolyzed alkaline water, and/or stabilized acidic water) for hydraulic fracturing, water flooding, well stimulation, and other processes that can improve recovery of a hydrocarbon (such as a crude oil or natural gas) from the reservoir.

### BACKGROUND OF THE INVENTION

Crude oil is the world's main source of hydrocarbons that are used as fuel and petrochemical feedstock. To enhance recovery of crude oil or other hydrocarbons from subterranean reservoirs, various methods for treating such reservoirs can be employed, known generally as “well treatments.” Well treatments can include a wide variety of methods that may be performed in oil and gas wells (including any portion thereof), such as drilling, completion, and workover methods. In this regard, drilling, completion, and workover methods can include, but are not limited to, drilling, fracturing, acidizing, logging, cementing, gravel packing, perforating, and conformance methods. Many of these well treatments are designed to enhance and/or facilitate the recovery of desirable fluids from a subterranean well.

One example of a well treatment is well stimulation, which generally refers to any of several post-drilling processes that are used to clean the wellbore, enlarge channels, increase pore space in the interval to be injected, and/or to otherwise make it possible for fluids to move more readily into and through the wellbore, its surrounding formation, and/or the reservoir. Indeed, in some cases, well stimulation processes are used to increase the productivity of a well, such as by removing damage in the vicinity of the wellbore or by superimposing a highly conductive structure onto the subterranean formation.

One commonly used stimulation technique is hydraulic fracturing also known as “hydraulic fracturing.” In this technique, a pressurized fracturing fluid (or hydraulic fracturing fluid) is used to create and/or propagate fractures that extend from the wellbore into reservoir formations so as to stimulate the potential for increased production, as compared to production prior to, or without, hydraulic fracturing. The fracturing fluid is typically injected into the formation at a sufficiently high pressure such that it creates and/or extends a fracture into the formation. Typically, when the pumping of the hydraulic fracturing fluid is finished, the fracture “closes” or reduces in size. Thus, the loss of fluid to surrounding permeable rock results as the fracture is reduced in width. In some cases, to prevent fractures from closing, a propping agent (or a proppant), which can be suspended in the hydraulic fracturing fluid, is used to “prop” or hold open the fractures that has been created, after the hydraulic pressure used to generate the fractures has been released.

Another example of a conventional method for treating a subterranean reservoir to enhance oil recovery (typically after the natural drive of the reservoir has decreased) is water flooding. In some cases, this treatment includes injecting water into the bottom of a formation or active well to increase the pressure within a reservoir and to stimulate production. In some cases, water flooding can also have the effect of driving or displacing hydrocarbons from a reservoir toward a production well.

While the aforementioned methods for treating subterranean reservoirs may be useful for enhancing hydrocarbon recovery, such methods are not necessarily without their shortcomings. Accordingly, it would be an improvement in the art to augment or even replace current techniques with other techniques.

### SUMMARY

This invention relates to systems and methods for increasing production from a hydrocarbon containing reservoir. More specifically, some implementations of the invention relate to the use of one or more electrolyzed aqueous solutions (such as electrolyzed acidic water, electrolyzed alkaline water, and/or stabilized acidic water) for treating a subterranean reservoir containing a hydrocarbon, such crude oil, alkenes, alkanes, and/or natural gas. While the described electrolyzed aqueous solutions can be used to treat a wellbore, a formation, and/or a subterranean reservoir in any suitable manner, in some non-limiting implementations, such solutions are used to improve hydraulic fracturing, water flooding, well stimulation, drilling, and other processes that can improve recovery of a hydrocarbon from the reservoir or can otherwise benefit from the use of electrolyzed water.

In some non-limiting implementations, the described systems and methods are used for hydraulic fracturing of a subterranean reservoir containing hydrocarbons. While such implementations can be carried out in any suitable manner, in some cases, they include injecting a hydraulic fracturing fluid into the subterranean reservoir, wherein the fracturing fluid includes electrolyzed water. Although the electrolyzed water can comprise electrolyzed acidic water, electrolyzed alkaline water, and/or stabilized acidic water, in some cases, the electrolyzed water comprises electrolyzed alkaline water. In other cases, however, the electrolyzed water comprises stabilized acidic water. Additionally, in some non-limiting implementations, the fracturing fluid, which includes electrolyzed water, also includes a proppant, such as a conventional sand, gel, foam, or slickwater-based proppant.

In other non-limiting implementations, the described systems and methods include using electrolyzed water for water flooding a hydrocarbon containing reservoir to improve recovery of hydrocarbons therefrom. Generally, such implementations include injecting electrolyzed water (e.g., electrolyzed alkaline water, stabilized acidic water, etc.) into an injection well and driving hydrocarbons in a corresponding hydrocarbon containing reservoir to a production well, where the hydrocarbons can be recovered.

In still other non-limiting implementations, the described systems and methods include injecting electrolyzed water into a wellbore to improve fluid flow within (or to otherwise stimulate) the wellbore, a corresponding formation, and/or a corresponding reservoir.

While the described systems and methods may be particularly useful for hydraulic fracturing, water flooding, and well stimulation, the described electrolyzed water (and its associated systems and methods) can be used for a wide variety of other well treatments, including, without limitation, for pre-hydraulic fracturing treatments, post-hydraulic fracturing treatments, for use as a carrying agent for one or more materials that are to be injected into a well/reservoir (e.g., a proppant, cross-linker, polymer, biocide, corrosion inhibitor, pH modifier, water flow inhibitor, etc.), as a pad, for down-hole decontamination techniques, with water-based drilling fluids, for treatment of disposal wells, and for a variety of other uses that can increase hydrocarbon recovery from a subterranean reservoir. Additionally, while the described systems and methods are described for use with hydrocarbon containing reservoirs, such systems and methods may be used in any other suitable application, including, without limitation, to stimulate groundwater wells, in geothermal applications, to precondition or induce rock to cave in mining, etc.

These features and advantages of the present invention will become more fully apparent from the following description and appended claims, or may be learned by the practice of the invention as set forth hereinafter.

### BRIEF DESCRIPTION OF THE SEVERAL DRAWINGS

In order that the manner in which the above-recited and other features and advantages of the invention are obtained and will be readily understood, a more particular description of the invention briefly described above will be rendered by reference to specific embodiments thereof that are illustrated in the appended drawings. Understanding that the drawings depict only typical embodiments of the invention and are not therefore to be considered to be limiting of its scope, the invention will be described and explained with additional specificity and detail through the use of the accompanying drawings in which:

FIG. 1 depicts a flowchart of a representative embodiment of a method for using electrolyzed water to treat a subterranean, hydrocarbon containing reservoir; and

FIG. 2 depicts a flowchart of a representative embodiment of a method for using electrolyzed water to effectuate hydraulic fracturing.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “another embodiment,” and similar language throughout this specification may, but do not necessarily, all refer to the same embodiment. Additionally, the singular forms “a”, “an” and “the” include plural referents, unless the context clearly dictates otherwise.

Furthermore, the described features, structures, or characteristics of the invention may be combined in any suitable manner in one or more embodiments. In the following description, numerous specific details are provided, such as examples of suitable additives, techniques for use with electrolyzed water, electrochemical cells, electrolyzed aqueous solutions (e.g., electrolyzed acidic water, electrolyzed alkaline water, and/or stabilized acidic water), proppants, hydraulic fracturing fluids, etc., to provide a thorough understanding of embodiments of the invention. One having ordinary skill in the relevant art will recognize, however, that the invention can be practiced without one or more of the specific details, or with other methods, components, materials, and so forth. In other instances, well-known structures, materials, or operations are not shown or described in detail to avoid obscuring aspects of the invention. Also, ranges may be expressed herein as from (or between) about one particular value, and/or to about another particular value. When any such a range is expressed, it is to be understood that another embodiment is from the one particular value and/or to the other particular value, along with any and all suitable combinations and sub-ranges within said range.

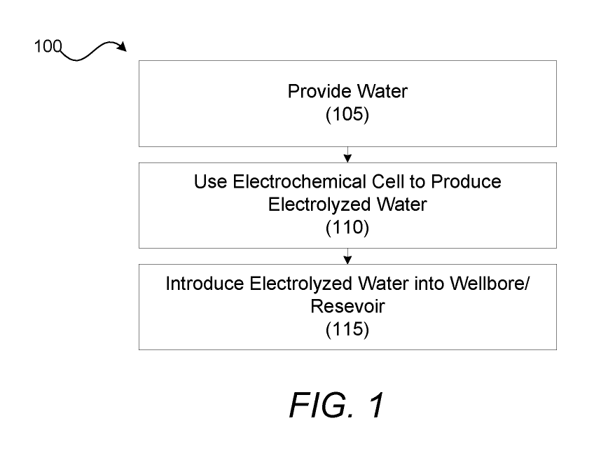

The described systems and methods relate generally to generating one or more electrolyzed aqueous solutions (such as electrolyzed acidic water, electrolyzed alkaline water, and/or stabilized acidic water) and then introducing or more of such solutions into a subterranean reservoir and/or wellbore in order to increase or otherwise facilitate recovery of hydrocarbons (which may include, without limitation, crude oil, alkanes, alkenes, natural gas, and/or other hydrocarbonaceous material) from the well. While such systems and methods can be used in any suitable manner, FIG. 1 shows one non-limiting embodiment of a typical method 100 for using an electrolyzed aqueous solution to treat a subterranean reservoir comprising hydrocarbons.

While each of the methods described herein (as well as any portion thereof) can be modified in any suitable manner (including by rearranging, reordering, adding to, removing, modifying, substituting, and otherwise modifying various portions of the method), FIG. 1 shows an embodiment in which the method begins at step 105 by obtaining/providing water (e.g., feed water for an electrochemical cell). In this regard, the water can be obtained from any suitable water source, including, without limitation, one or more aquifers, rivers, streams, wells, lakes, ponds, seas, oceans, reservoirs, municipal water supplies, etc. Typically, water can be obtained from a water source (e.g., an aquifer or from the sea) and can be transported to an injection well site by truck or by surface facilities including (for example) pumps, filters, water treatment equipment, and/or flow lines. In some embodiments, the feed water is optionally stored near the site (e.g., in a pond, reservoir, tank, tanker truck, etc.) and then pumped to the electrochemical cell or cells as needed.

In some embodiments, before being electrolyzed, the feed water is treated (e.g., filtered, distilled, subjected to a reverse osmosis process, and/or otherwise treated) to remove any undesired contaminants (e.g., chlorine, dirt, debris, silt, minerals, and/or other materials).

Indeed, in some embodiments, an electrolyte (such as a salt) is added to the feed water. In such embodiments, any suitable electrolyte can be added to the water, including, without limitation, NaCl, LiCl, KCl, etc. In some implementations, however, NaCl is added to the water to improve the water's ability to act as an electrolyte solution in an electrochemical cell (discussed below).

Where the feed water comprises a salt (e.g., NaCl), the salt can be present in the feed water at any suitable concentration that allows the electrochemical cell to produce or be used to produce electrolyzed alkaline water, electrolyzed acidic water, and/or stabilized acidic water. In one non-limiting example, salt is present in the feed water at between about a 1% and about a 50% saturation. In another example, salt is present in the feed water at a concentration of between about a 10% and about a 30% saturation. In still another non-limiting example, salt is present in the feed water at a concentration between about a 15% and about a 25% saturation (e.g., 20% ±2%).

At step 110, FIG. 1 shows the method 100 continues as an electrochemical cell (including any suitable electrolytic cell or similar cell) is used to produce electrolyzed water (e.g., electrolyzed alkaline water, electrolyzed acidic water, and/or stabilized acidic water). While this can be done in any suitable manner, in some non-limiting embodiments, a feed water solution (e.g., a saline solution) is supplied to an electrolytic or electrochemical cell that includes both an anode chamber and a cathode chamber, which respectively house one or more anode electrodes and cathode electrodes, as are known in the art (e.g., dimensionally stable electrodes, flat plate electrodes, mesh electrodes, ceramic electrodes, and/or other novel or conventional electrodes comprising any suitable electrode material).

While the cathode and electrode chambers in the electrochemical cell can have any suitable relationship with respect to each other, in some non-limiting embodiments, the two chambers are separated by a membrane (e.g., a polymer membrane, a ceramic membrane, a salt bridge, etc.) that is capable of allowing the passage of certain ions from one chamber to the other. Indeed, in some embodiments, the present invention employs electrochemical cells having separate anode and cathode chambers, which allow the cells to produce separate anolyte and catholyte streams. In other embodiments, however, the present invention employs electrochemical cells that allow for some mixing between the anolyte and catholyte streams. In this regard, the mixing can occur in any suitable location and manner. In one non-limiting example, while the anode and cathode chambers are separated by a separator (e.g., a membrane), some embodiments of such a separator allow some amount of the content of the two chambers to mix within the cell. In another non-limiting example, the anolyte and catholyte streams are mixed outside of either of the anode or cathode chambers (e.g., by being mixed in a container or tubing disposed separate from the anode and cathode chambers). In still another non-limiting example, a portion of the contents of one chamber is directed into the other (e.g., some of the catholyte stream is channeled into the anode chamber).

When the feed water solution (e.g., saline solution) is placed in contact with the various electrodes in the cell, electrolysis occurs once the electrodes are electrically charged by a power source. In some non-limiting embodiments, during the electrochemical reaction, positively charged ions (e.g., NaOH) migrate to the negative electrode (e.g., the cathode) and, in some cases, negatively charged ions (e.g., precursors for hypochlorous acid (HOCl) or another reaction) migrate towards the positive electrode (e.g., anode). Thus, the feed water solution can be cathodically electrolyzed in the cathode chamber to produce electrolyzed water as an antioxidant solution called alkaline catholyte (or electrolyzed alkaline water). The feed water solution can also be anodically electrolyzed in the anode chamber to produce electrolyzed water as an oxidant solution called anolyte (or electrolyzed acidic water), whose pH is modified in the process. In some instances, the electrolyzed acidic water is a strong oxidizing solution. More specifically, in some non-limiting embodiments in which acidic electrolyzed water is generated through the electrolysis of a dilute aqueous sodium chloride (NaCl) solution, the Cl⁻ ions are electrochemically oxidized to form Cl₂ gas at the anode, which gas can be partially hydrolyzed to form hypochlorous acid (HOCl).

In some cases, the electrolyzed acidic water and the electrolyzed alkaline water are mixed to produce stabilized acidic water. In this regard, stabilized acidic water can be formed in any suitable manner, including, without limitation, by allowing electrolyzed alkaline water to mix with electrolyzed acidic water in the electrochemical cell (e.g., through the use of a separator that allows a portion of the contents of at least one chamber to mix with the contents of the other chamber, through the use of channels that direct a portion of the contents of at least one chamber to the other, etc.), outside the cell (e.g., in a container that is separated from the anode and cathode chambers, in tubing that combines a portion of the anolyte stream and a portion of the catholyte stream, within a wellbore, within a reservoir, within a formation, etc.), and/or in any other suitable manner.

With respect to the electrolyzed acidic water, that water can have any suitable pH less than about 7. In some non-limiting embodiments, however, it has a pH between about 1 and about 7. In some alternate embodiments the electrolyzed acidic water has a pH of between about 3 and about 6, alternatively between about 1 and about 6, alternatively between about 2 and about 6, or alternatively between about 4 and about 6 (e.g., between about 1.7 and about 4).

Although the electrolyzed alkaline water from the catholyte stream can have any suitable pH greater than about 7, in some embodiments, it has a pH between about 7 and about 14. In other embodiments, the electrolyzed alkaline water has a pH between about 8 and about 13, or, alternatively, between about 8 and about 12, between about 9 and about 13, between about 10 and about 13, or between about 9 and about 11.

The stabilized acidic water can have any pH that allows such a solution to be acidic. In some non-limiting embodiments, however, the stabilized acidic water has a pH between about 4 and about 6. In some other embodiments, the stabilized acidic water has a pH between about 4 and about 6, alternatively between about 4 and about 5, alternatively between about 4.5 and about 5.5, and alternatively between about 5 and about 6.

For the various processes described herein, the electrolyzed water that is utilized can be (in certain embodiments) an electrolyzed acidic water, an electrolyzed alkaline water, a stabilized acidic water, or combinations thereof. In this regard, different considerations that can be taken into account in the decision as to use electrolyzed acidic water, electrolyzed alkaline water, and/or stabilized acidic water can include the type of formation to be treated, the condition of the reservoir being treated, the type of operation being performed, and the like. Additionally, while electrolyzed acidic water may be useful in a wide variety of applications, in some non-limiting embodiments, it may be beneficial for use: in deactivating down-hole biologics, in acid hydraulic fracturing, in dissolving/removing fines and debris, in clearing fractures, for treating down-hole contamination, in hydrogen-sulfide containing wells, as a carrying agent, as a pad, and in virtually any other application in which the use of an acidic solution in a wellbore, a formation, or a reservoir may be beneficial. Similarly, while stabilized acidic water may have a variety of beneficial characteristics, in some embodiments, it is used, in any suitable situation, as a substitute for electrolyzed acidic water, and may have a better pH stability (i.e., maintain its pH and oxidation reduction potential better) than electrolyzed acidic water.

Also, while electrolyzed alkaline water may be useful in a wide variety of applications, in some non-limiting embodiments, it is used to dissolve/remove fines and debris, to clear fractures, as a carrying agent, as a pad, and for a virtually any other application in which use of an alkaline solution in a wellbore, a formation, and/or a reservoir may be useful. Indeed, because electrolyzed alkaline water can help to improve laminar flow, and thereby reduce emulsification, flocculation, and other perturbation of liquid flow, in some embodiments, such water is used as a carrier to carry desired materials and/or additives (e.g., proppant) to a subterranean reservoir.

Continuing with the method 100 of FIG. 1, step 115 shows the method can continue as the electrolyzed water (e.g., electrolyzed acidic water, electrolyzed alkaline water, and/or stabilized acidic water) is introduced into a wellbore and/or reservoir. While this electrolyzed water can be sent to the wellbore directly from the electrochemical cell, in some non-limiting embodiments, after the electrolyzed water is generated, it is stored (e.g., in a pond, in tanks, in tankers, in reservoirs, etc.) and then pumped to the wellbore (and/or other desired location, such as a formation, a reservoir, an inlet well, a production well, etc.) on demand.

While the electrolyzed water can be injected or otherwise introduced into a wellbore, formation, or other location for any suitable purpose, in some non-limiting embodiments, the electrolyzed water is introduced in a hydraulic fracturing process, a water flooding process, and/or well stimulation process; each of which is discussed below in more detail.

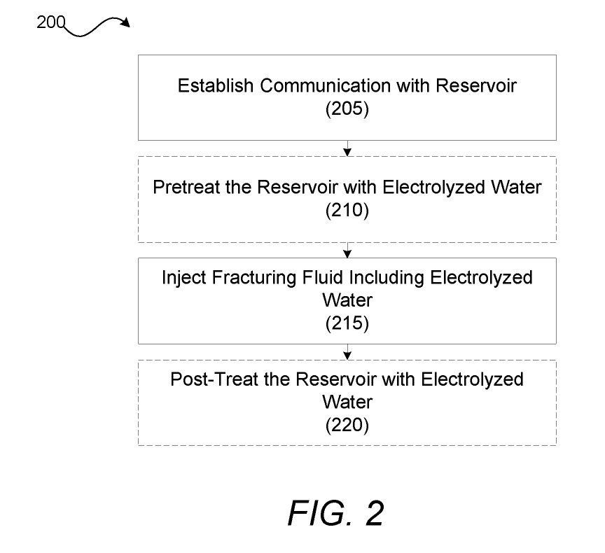

In some non-limiting embodiments, the present invention provides a process for performing hydraulic fracture stimulation treatments (or hydraulic fracturing) in a reservoir/formation, where the reservoir/formation is intersected by a wellbore in which, most commonly, a casing or liner will generally have been cemented in place (typically referred to as a “cased hole”). In this regard, FIG. 2 shows that, in some embodiments, the hydraulic fracturing method 200 includes a first step (205) of initiating the hydraulic fracturing by first ensuring pressure communication between the wellbore and the subterranean formation by any suitable technique, such as perforating the casing at the desired point of communication and, thereafter (as shown at step 215, skipping optional step 210 at this point) increasing the wellbore pressure by pressurizing an electrolyzed-water-containing fracturing fluid (or hydraulic fracturing fluid) in the well to cause the subterranean formation to fracture.

In some cases, rapid increases of pressure at the bottom of a well can cause the formation rock to fail, causing the formation to split, and thereby creating a fracture into which the fracturing fluid can be pumped. In certain embodiments, by initiating injection of fluids in a higher effective stress layer, the fracture height growth is not restricted by the stresses in a bounding layer. As pumping continues, the fracture can grow, favoring increasing the fracture height, rather than the generation of significant fracture length. This trend can continue as additional hydraulic fracturing fluid is pumped into the formation.

The hydraulic fracturing fluid can have any suitable viscosity that allows it to fracture (or to propagate fractures in) a formation as it is injected into a reservoir. In some embodiments, however, the hydraulic fracturing fluid is relatively viscous and can appear gelatinous at ambient temperature. Some non-limiting examples of suitable viscosities of the hydraulic fracturing fluid range from about 1 to about 1,000 cp, and more typically from about 100 to about 700 cp, and most typically from about 200 to about 500 cp (e.g., between about 250 cp and about 450 cp).

Where the hydraulic fracturing fluid includes electrolyzed water (e.g., electrolyzed acidic water, electrolyzed alkaline water, and/or stabilized acidic water), the hydraulic fracturing fluid can include any suitable concentration of the electrolyzed water that allows the hydraulic fracturing fluid to perform its intended function. In some embodiments, the hydraulic fracturing fluid includes from about 1% up to 10% by volume of the electrolyzed water. In some alternative embodiments, the hydraulic fracturing fluid includes up about 20% electrolyzed water, or alternatively up to about 30%, up to about 40%, up to about 50%, up to about 60%, up to about 70%, up to about 80%, up to about 90%, or even up to about 100% (e.g., where pure electrolyzed water is injected directly into a formation at high pressure).

In certain embodiments, the hydraulic fracturing fluid comprises electrolyzed acidic water. In some such embodiments, the electrolyzed acidic water for use in the hydraulic fracturing fluid has a pH of less than about 7, alternatively less than about 6.9, and as low as about 1. Indeed, in certain embodiments, the electrolyzed acidic water has a pH of between about 1 and about 7, alternatively between about 1.5 and about 3, alternatively between about 2 and about 4, alternatively between about 3 and about 5, and alternatively between about 4 and about 6. In certain other embodiments, the hydraulic fracturing fluid has a pH of between about 3.5 and about 6.5, alternatively between about 3.5 and about 5, alternatively between about 5 and about 6.5, alternatively 2 and 3, and alternatively between about 2.1 and about 2.5.

Where the hydraulic fracturing fluid comprises electrolyzed acidic water, such water can have any suitable oxidation reduction potential that allows the hydraulic fracturing fluid to perform its intended function. In some non-limiting embodiments, the electrolyzed acidic water for use in a hydraulic fracturing fluid has an oxidation reduction potential of between about 750 mV and about 1400 mV, alternatively between about 750 mV and about 900 mV, alternatively between about 900 mV and about 1100 mV, alternatively between about 900 mV and about 1300 mV, alternatively between about 1100 mV and about 1400 mV, and alternatively between about 1000 and about 1200 mV.

In embodiments in which the hydraulic fracturing fluid comprises electrolyzed alkaline water, the electrolyzed water added to the hydraulic fracturing fluid can have any suitable pH. Indeed, in some non-limiting embodiments, the electrolyzed alkaline water has a pH of between about 7.1 and about 14, alternatively between about 7.5 and about 8.5, alternatively between about 8.5 and about 9.5, alternatively between about 9.5 and about 10.5, alternatively between about 10.5 and about 11.5, alternatively between about 11.5 and about 12.5, and alternatively between about 12.5 and about 14. In certain embodiments, the electrolyzed alkaline water for use as a hydraulic fracturing fluid has a pH greater than about 9, and alternatively greater than about 11.

Where the hydraulic fracturing fluid comprises electrolyzed alkaline water, such electrolyzed water can have any suitable oxidation reduction potential that allows the hydraulic fracturing fluid to perform its intended function. Indeed, in some embodiments, the electrolyzed alkaline water in the hydraulic fracturing fluid has an oxidation reduction potential of between about −350 mV and about −1300 mV, alternatively between about −350 mV and about −600 mV, alternatively between about −600 mV and about −950 mV, alternatively between about −600 mV and about −980 mV, and alternatively between about −950 mV and about −1300 mV.

Where the hydraulic fracturing fluid comprises stabilized acidic water, such water can have any suitable acidic pH. In some embodiments, however, the stabilized acidic water has a pH between about 4 and about 6. In other embodiments, the stabilized acidic water has a pH between about 4 and about 6, alternatively between about 4 and about 5, alternatively between about 4.5 and about 5.5, and alternatively between about 5 and about 6.

After establishing communication with a reservoir (e.g., in a higher effective stress layer) (as discussed above with respect to step 205 in FIG. 2), in some embodiments, high pressure pumping is subsequently started (as discussed above with respect to step 215). While the hydraulic fracturing fluid can be pumped into the reservoir at any suitable pressure, in some embodiments, it is pumped at pressures of up to about 15,000 Psi, alternatively up to about 10,000 Psi, alternatively at pressures of between about 5,000 Psi and about 15,000 Psi, and alternatively at pressures between about 5,000 Psi and about 10,000 Psi.

In some embodiments, during the pumping, a proppant (e.g., silica sand, resin-coated sand, a ceramic, a gel, a foam, and/or another propping agent) is added to the fracturing fluid containing the electrolyzed water. The timing of the addition and the quantity of proppant used can be based upon any suitable factor, including, without limitation, the expected final dimensions of the fracture and the required proppant concentration that will be needed within the fracture to achieve the required production performance, as is known in the art. The amount of fracturing fluid injected is often determined based upon the desired size of the fracture.

In certain embodiments (and as shown at step 210 in FIG. 2), the electrolyzed water (e.g., stabilized acidic water, electrolyzed alkaline water, etc.) is optionally used as a pre-treatment fluid to prepare a wellbore, formation, reservoir, and/or other location prior to a hydraulic fracturing process. In certain other embodiments (as shown at step 220 in FIG. 2), the electrolyzed water is optionally used as a post-treatment fluid, which is supplied to a wellbore, a formation, a reservoir, etc. after a hydraulic fracturing process has been completed. Depending upon the formation, the use of electrolyzed water for pre-treatment and/or post-treatment of formations that are subject to hydraulic fracturing processes can help with the removal of fines and/or particulate material, can dissolve or break down certain particles or portions of the formation, and/or (when used as a pre-treatment fluid) can improve the results of the hydraulic fracturing process.

In all uses related to the hydraulic fracturing of a formation, either as a pre-treatment fluid, a post-treatment fluid, or as the hydraulic fracturing fluid, the electrolyzed water can make up a portion of the fluid that is utilized and combined with other fluids or chemicals, can be used alone, or can be used without the addition of other chemicals, materials and/or fluids.

Turning now to water flooding, in certain embodiments of the present invention, electrolyzed water is used for water flooding methods. While such methods can be performed in any suitable manner, in some embodiments, such methods include introducing a sufficient amount of electrolyzed water (e.g., stabilized acidic water, electrolyzed acidic water, and/or electrolyzed alkaline water) and at a sufficient pressure into a formation (e.g., the bottom of a formation, through an injection well (or wells)) to drive hydrocarbons from the formation (e.g., via a production well (or wells)), where the hydrocarbons are recovered. In certain embodiments, however, one or more of the electrolyzed waters described herein are used as a pre- and/or post-treatment fluid for water flooding operations. In one non-limiting example, the wellbore of an injection well is first treated with electrolyzed acidic water, electrolyzed alkaline waters, and/or stabilized acidic water, prior to commencing of water flooding operations.

While water flooding can be performed at any suitable stage in the existence of a reservoir, in some embodiments, the well injection composition described herein is used in a flooding operation (e.g., as secondary flooding, as opposed to a primary recovery operation which relies on natural forces to move the fluid) to recover a production fluid (e.g., oil from a subterranean formation). The flooding can also be repeated one or more times to increase the amount of production fluid recovered from the reservoir. In subsequent flooding operations, the injection fluid can be replaced with a fluid that is miscible or partially miscible with the hydrocarbons (e.g., oil) being recovered.

In certain embodiments, the injection well can include a cement sheath or column that has been positioned or created in the annulus of a wellbore, wherein the annulus is disposed between the wall of the wellbore and a conduit, such as a casing, running through the wellbore. Thus, the compositions described herein can pass through the casing into the subterranean formation during flooding.

As previously stated, depending on the characteristics of the formation, reservoir, etc. that is being treated, the electrolyzed water can include electrolyzed acidic water, electrolyzed alkaline water, and/or stabilized acidic water. Where the flooding process includes the use of electrolyzed acidic water, such water can have any suitable pH that allows the flooding process to be used to recover hydrocarbons from a reservoir. In some embodiments, the electrolyzed acidic water used for water flooding processes has a pH as low as about 1 and has high as about 7, or alternatively as high as about 6.9. In certain embodiments, however, the electrolyzed acidic water has a pH of between about 1 and about 3, alternatively between about 2 and about 4, alternatively a between about 3 and about 5, alternatively between about 4 and about 6. In still other embodiments, the electrolyzed water used for water flooding processes has a pH of between about 3.5 and about 6.5, alternatively between about 3.5 and about 5, alternatively between about 5 and about 6.5, alternatively between about 2 and about 3, and alternatively between about 2.1 and about 2.5.

Where the electrolyzed water used for water flooding comprises electrolyzed acidic water, such water can have any suitable oxidation reduction potential that allows the flooding process to recover hydrocarbons. In some embodiments, the electrolyzed acidic water used for water flooding processes has an oxidation reduction potential of between about 750 mV and about 1400 mV, alternatively between about 750 mV and about 900 mV, alternatively between about 900 mV and about 1100 mV, alternatively between about 900 mV and about 1300 mV, and alternatively between about 1100 mV and about 1400 mV. In certain embodiments, the electrolyzed acidic water has an oxidation reduction potential of between about 1000 and about 1200 mV.

In embodiments in which the flooding process uses electrolyzed alkaline water, such water can have any suitable pH. In some embodiments, the electrolyzed alkaline water used for water flooding processes has a pH of between about 7.1 and about 14, alternatively between about 7.5 and 8.5, alternatively between about 8.5 and about 9.5, alternatively between about 9.5 and about 10.5, alternatively between about 10.5 and about 11.5, alternatively between about 11.5 and about 12.5, and alternatively between about 12.5 and about 14. In still other embodiments, the electrolyzed alkaline water for water flooding has a pH greater than about 9, and alternatively greater than about 11.

In embodiments in which electrolyzed alkaline water is used for a water flooding process, such water can have any suitable oxidation reduction potential. In some embodiments, the electrolyzed alkaline water has an oxidation reduction potential of between about −350 mV and about −1300 mV, alternatively between about −350 mV and about −600 mV, alternatively between about −600 mV and about −950 mV, and alternatively between about −950 mV and about −1300 mV.

Where stabilized acidic water is used for a water flooding process, such water can have any suitable acidic pH. In some embodiments, however, the stabilized acidic water has a pH between about 4 and about 6. In other embodiments, the stabilized acidic water has a pH between about 4 and about 6, alternatively between about 4 and about 5, alternatively between about 4.5 and about 5.5, and alternatively between about 5 and about 6.

The water injected into the injection well (or other suitable location) can include any suitable concentration of electrolyzed water. In some embodiments, the flooding water comprises up to about 20% by volume electrolyzed water (e.g., stabilized acidic water, electrolyzed acidic water, and/or electrolyzed alkaline water), alternatively up to about 30% by volume electrolyzed water, alternatively up to about 40% by volume electrolyzed water, alternatively up to about 50% by volume electrolyzed water, alternatively up to about 60% by volume electrolyzed water, alternatively up to about 70% by volume electrolyzed water, alternatively up to about 80% by volume electrolyzed water, and alternatively up to about 90% by volume electrolyzed water. In certain other embodiments, pure electrolyzed water is used for water flooding.

In certain embodiments, the apparatus used for water flooding includes at least one pump for supplying water from holding means, such as a pond, or the like to the electrochemical cell. In some embodiments, the apparatus includes at least one pump for supplying electrolyzed water from the electrochemical cell to the reservoir.

With reference now to well stimulation, according to the described systems and methods, well stimulation is a process that is conducted to improve the flow of hydrocarbons from a reservoir into the wellbore, and typically includes the injection of electrolyzed water (e.g., stabilized acidic water, electrolyzed acidic water, and/or electrolyzed alkaline water) along with various chemicals into the wellbore and/or formation.

In some embodiments in which well stimulation includes the use of electrolyzed acidic water, such water can have any suitable pH. In some embodiments, the electrolyzed acidic water used for well stimulation has a pH of less than about 7, alternatively less than about 6.9, and as low as about 1. Indeed, in certain embodiments, the electrolyzed acidic water has a pH of between about 1 and about 7, alternatively between about 1.5 and about 3, alternatively between about 2 and about 4, alternatively between about 3 and about 5, and alternatively between about 4 and about 6. In certain other embodiments, the electrolyzed water for well stimulation has a pH of between about 3.5 and about 6.5, alternatively between about 3.5 and about 5, alternatively between about 5 and about 6.5, alternatively about 2 and about 3, and alternatively between about 2.1 and about 2.5.

Where the electrolyzed water used for well stimulation comprises electrolyzed acidic water, such water can have any suitable oxidation reduction potential. In some embodiments, the electrolyzed acidic water used for well stimulation has an oxidation reduction potential of between about 750 mV and about 1400 mV, alternatively between about 750 mV and about 900 mV, alternatively between about 900 mV and about 1100 mV, alternatively between about 900 mV and about 1300 mV, and alternatively between about 1100 mV and about 1400 mV. In certain embodiments, the electrolyzed acidic water has an oxidation reduction potential of between about 1000 and about 1200 mV.

In some embodiments in which the described well stimulation process uses electrolyzed alkaline water, such water can have any suitable pH. In some embodiments, the electrolyzed alkaline water used for well stimulation processes has a pH of between about 7.1 and about 14, alternatively between about 7.5 and about 8.5, alternatively between about 8.5 and about 9.5, alternatively between about 9.5 and about 10.5, alternatively between about 10.5 and about 11.5, alternatively between about 11.5 and about 12.5, alternatively between about 12.5 and about 14. In still other embodiments, the electrolyzed alkaline water used for well stimulation has a pH greater than about 9, and alternatively greater than about 11.

In embodiments in which electrolyzed alkaline water is used for well stimulation processes, such water can have any suitable oxidation reduction potential. In some embodiments, the electrolyzed alkaline water has an oxidation reduction potential of between about −350 mV and about −1300 mV, alternatively between about −350 mV and about −600 mV, alternatively between about −600 mV and about −950 mV, and alternatively between about −950 mV and about −1300 mV.

Where stabilized acidic water is used for a well stimulation process, such water can have any suitable acidic pH. In some embodiments, however, the stabilized acidic water has a pH between about 4 and about 6. In other embodiments, the stabilized acidic water has a pH between about 4 and about 6, alternatively between about 4 and about 5, alternatively between about 4.5 and about 5.5, and alternatively between about 5 and about 6.

In certain embodiments, the electrolyzed water is injected into the wellbore of a production well (or other suitable location) to remove all or a portion of the fines or other particulate matter that may be present. In alternate embodiments, the electrolyzed water is injected to remove or reduce the formation of scale deposits within the wellbore.

In certain embodiments, in addition to electrolyzed water, the well stimulation fluids include polymers, such as a soluble polysaccharide. In certain embodiments, the polymer can be included to increase the viscosity of the fracturing fluid, which can aid in the creation of a fracture, and thicken the aqueous solution so that solid proppant particles can be employed and delivered to the fracture.

In certain embodiments, one or more of the described well treatment fluids (i.e., for well stimulation or any other technique) includes at least one polymer. In some embodiments, the classes of polymers are polysaccharides or synthesized polymers. Some non-limiting examples of suitable polymers include galactomannan polymers and derivatized galactomannan polymers; starch; xanthan gums; hydroxycelluloses; hydroxyalkyl celluloses; polyvinyl alcohol polymers (e.g., homopolymers of vinyl alcohol and copolymers of vinyl alcohol and vinyl acetate); and polymers (e.g., homopolymers, copolymers, and terpolymers) that are the product of a polymerization reaction comprising one or more monomers selected from the group consisting of vinyl pyrrolidone, 2-acrylamido-2-methylpropanesulfonic acid, acrylic acid and acrylamide, methacrylic acid, styrene sulfonic acid, acrylamide and other monomers currently used for oil well treatment polymers, among others. In certain embodiments, the polymer comprises a polyvinyl alcohol polymer prepared by hydrolyzing vinyl acetate polymers. In some embodiments, the polymer is water-soluble. Specific polymers that can be used include, but are not limited to, hydrolyzed polyacrylamide, guar gum, hydroxypropyl guar gum, carboxymethyl guar gum, carboxymethylhydroxypropyl guar gum, hydroxyethyl cellulose, carboxymethylhydroxyethyl cellulose, hydroxypropyl cellulose, copolymers of acrylic acid and acrylamide, xanthan, starches, and mixtures thereof, among others.

In certain embodiments, in addition to electrolyzed water, the well stimulation fluids (or other electrolyzed water containing solutions) include one or more additives, such as water, oils, salts (including, but not limited to, organic salts), cross-linkers, polymers, biocides, corrosion inhibitors and dissolvers, pH modifiers (e.g., acids and bases), breakers, metal chelators, metal complexors, antioxidants, wetting agents, polymer stabilizers, clay stabilizers, scale inhibitors and dissolvers, wax inhibitors and dissolvers, asphaltene precipitation inhibitors, water flow inhibitors, fluid loss additives, chemical grouts, diverters, sand consolidation chemicals, proppants, permeability modifiers, viscoelastic fluids, gases (e.g., nitrogen and carbon dioxide), foaming agents and/or other suitable materials. While such additives can serve any suitable function, in some embodiments, they are included to enhance the stability of the fluid composition and to prevent breakdown caused by exposure to oxygen, temperature change, trace metals, constituents of water added to the fluid composition, and to prevent non-optimal cross-linking reaction kinetics.

In certain embodiments, the electrolyzed water used for well stimulation is capable of removing debris in the wellbore. In other embodiments, the electrolyzed water is used to dissolve particulate material within the wellbore. In some embodiments, the well stimulation fluids are supplied directly to a desired location (e.g., using tubing, such as coiled tubing).

The described systems and methods can be modified in any suitable manner. In one example, the electrolyzed water (e.g., electrolyzed acidic water or electrolyzed basic water) is optionally combined with one or more additives, such as nanoparticles having certain desired properties for stimulation, flooding, and/or fracturing. In this regard, desired properties can include, without limitation, properties relating to reduction of friction, biocidal properties, oxygen scavenging properties, formation control, scale inhibition, and the like. In some embodiments, the additives, including the nanoparticle additives, assist with the separation of various fluids, such as hydrocarbon and/or oil-based fluids and water.

In another non-limiting example, in some instances, the described systems and methods use one or more of the described electrolyzed waters in disposal wells. In this regard, disposal wells may be porous underground rock formations that do not actively produce gas or oil, and into which water recovered during a drilling operation can be injected. Thus, in certain embodiments, one or more of the described electrolyzed waters (e.g., electrolyzed acidic water, electrolyzed alkaline water, and/or stabilized acidic water) are injected into a disposal well (including, without limitation, as either a pre-injection or post-injection fluid). In some other embodiments, however, the electrolyzed waters are injected as a co-injection fluid. In certain instances, water and/or hydraulic fracturing fluids and/or other fluids utilized for well stimulation and/or fracturing are also injected into disposal wells.

In still another non-limiting example, water wells are treated with one or more of the electrolyzed waters described herein (i.e., electrolyzed acidic water, electrolyzed alkaline water, and/or stabilized acidic water). As used herein, the term water wells may refer to any of the various known means for accessing or recovering water from an accessible underground aquifer, such as through digging, driving, boring, and/or drilling. While the described electrolyzed waters can be used to perform any process associated with water wells, in some embodiments, one or more of the described electrolyzed waters is used to stimulate and/or drive (similar to what is described for water flooding) water from the aquifer to a recovery well. In still other embodiments, the described electrolyzed waters are used to clean or treat the wellbores of water wells.

In another example, the described electrolyzed water can be used with any other fluid or chemical used in the recovery of hydrocarbons from a reservoir, or for any other suitable treatment of a reservoir, wellbore, formation, and/or other location. By way of non-limiting example, the described electrolyzed water can be used in water-based drilling fluids.

The various aspects of the invention described herein can be practiced independently or together. Indeed, in certain embodiments of the present invention, two or more of the described electrolyzed waters are utilized for one or more of the various processes described herein (for example, hydraulic fracturing, water flooding, well stimulation, and/or injection of waters into disposal wells). Additionally, while the various electrolyzed waters can be used together, in some embodiments, two or more of the various electrolyzed waters are used in series, in any suitable order and combination. In one non-limiting example, in a first step, electrolyzed acidic water is injected into a formation for the purpose of hydraulic fracturing of the formation, and in a second subsequent step, electrolyzed alkaline water is injected into a formation also for the purpose of hydraulic fracturing of the formation. In another non-limiting example, in a first step, a first electrolyzed water (selected from electrolyzed acidic water, electrolyzed basic water, and stabilized acidic water) is used to treat a wellbore, and in a subsequent second step, a second electrolyzed water (selected from electrolyzed acidic water, electrolyzed basic water, and stabilized acidic water) is injected into a formation for well stimulation, hydraulic fracturing, or water flooding. In certain embodiments, electrolyzed water can be used for both pre-treatment and post-treatment of a wellbore or formation, and a solution that includes electrolyzed water can be used for well stimulation, well treatment, hydraulic fracturing, or water flooding. One of skill in the art will recognize that the present disclosure includes the many possible combinations of treatment of wellbores, reservoirs, and formations with one or more electrolyzed waters, both in combination and as applied to the wellbore, reservoirs, and/or formation in series.

In certain embodiments, the use of the electrolyzed water for the various processes described herein, including use for pre-treatment of wells and/or formations for hydraulic fracturing processes, as a component for hydraulic fracturing processes; for the post-treatment after hydraulic fracturing processes; for use in well stimulation; for use in removing or reducing the presence of fines, particulate matter, and/or scale formation; for water flooding; in water wells; in disposal wells; or for use in water-based drilling fluids, can be effective in reducing the surface tension within the entire well, including within the formation, within the wellbore, and from the source of the water (including feed water and/or electrolyzed water) which can be tanker, trucks, holding tanks, reservoirs, ponds, etc. In certain embodiments, the electrolyzed water (e.g., electrolyzed alkaline water) can be particularly useful in reducing the tension within the wellbore. Use of the electrolyzed waters can also be effective for the reduction of friction within the formation, within the wellbore, and in the components utilized for transporting the water, including, without limitation, tanker trucks, pumps, and holding tanks.

While specific embodiments and examples of the present invention have been illustrated and described, numerous modifications come to mind without significantly departing from the spirit of the invention. Additionally, the described embodiments and examples are all to be considered in all respects as being illustrative only and not restrictive in any manner. The scope of the invention is, therefore, indicated by the appended claims, rather than the foregoing description. All changes that come within the meaning and range of equivalency of the claims are to be embraced within their scope.

1. A method for treating a subterranean, hydrocarbon containing reservoir, the method comprising:
supplying a feed water to an electrochemical cell to generate an electrolyzed aqueous solution, wherein the electrolyzed aqueous solution comprises a pH selected from (i) between about 2 and about 6 and (ii) greater than 9;
mixing at least one of a hydraulic fracturing fluid and a polymer into the electrolyzed aqueous solution; and
injecting the electrolyzed aqueous solution into the subterranean, hydrocarbon containing reservoir, wherein the electrolyzed aqueous solution is generated prior to any feed water being injected into the subterranean, hydrocarbon containing reservoir.

2. The method of claim 1, wherein the electrolyzed aqueous solution comprises electrolyzed alkaline water.

3. The method of claim 1, wherein the electrolyzed aqueous solution comprises electrolyzed acidic water.

4. The method of claim 1, wherein the method comprises a process selected from hydraulic fracturing of the subterranean, hydrocarbon containing reservoir; water flooding the subterranean, hydrocarbon containing reservoir; and improving fluid flow of the subterranean, hydrocarbon containing reservoir, a wellbore of a production well, or an injection well.

5. The method of claim 1, wherein the hydraulic fracturing fluid comprises a proppant.

6. A method for water flooding a subterranean, hydrocarbon containing reservoir to improve recovery of the hydrocarbons from the reservoir, the method comprising:
supplying feed water to an electrochemical cell to generate an electrolyzed aqueous solution;
injecting the electrolyzed aqueous solution into the subterranean reservoir under pressure to drive the hydrocarbons in the hydrocarbon containing reservoir to a production well;
mixing at least one of a hydraulic fracturing fluid and a polymer into the electrolyzed aqueous solution; and
recovering hydrocarbons from the production well, wherein the electrolyzed aqueous solution is generated prior to any feed water being injected into the subterranean reservoir.

7. The method of claim 6, wherein the electrolyzed aqueous solution comprises electrolyzed alkaline water.

8. The method of claim 7, wherein the electrolyzed alkaline water has a pH greater than about 9.

9. The method of claim 6, wherein the electrolyzed aqueous solution comprises electrolyzed acidic water.

10. The method of claim 9, wherein the electrolyzed acidic water has a pH of between about 2 and about 6.

11. The method of claim 6, wherein the hydraulic fracturing fluid comprises a proppant.

12. A method for treating a portion of subterranean well, the method comprising:
supplying a feed water to an electrochemical cell to generate an electrolyzed acidic water and an electrolyzed alkaline water, wherein a salt is present in the feed water at a saturation between about 1% and about 50%;
mixing the electrolyzed alkaline water and the electrolyzed acidic water to form a stabilized acidic water;
mixing at least one of a hydraulic fracturing fluid and a polymer into the stabilized acidic water; and
injecting the stabilized acidic water into the subterranean well.

13. The method of claim 12, wherein the electrolyzed alkaline water and the electrolyzed acidic water are mixed prior to being introduced into the subterranean well.

14. The method of claim 12, wherein the stabilized acidic water comprises a pH between about 4 and about 6.

15. The method of claim 12, wherein the method comprises a process selected from hydraulic fracturing of the subterranean well; water flooding the subterranean well; and improving fluid flow of the subterranean well, a wellbore of a production well, or a wellbore of an injection well.

16. The method of claim 12, wherein the subterranean well is selected from a water well and a well containing hydrocarbons.

17. The method of claim 12, wherein the hydraulic fracturing fluid comprises a proppant.
